(19) United States
(12) Patent Application Publication
(10) Pub. No.: US 2021/0207633 A1
(43) Pub. Date: Jul. 8, 2021

(54) MOTOR VEHICLE FASTENING SYSTEM FOR FASTENING A FIRST MOTOR VEHICLE COMPONENT TO A SECOND MOTOR VEHICLE COMPONENT

(71) Applicant: Huf Hülsbeck & Fürst GmbH & Co. KG, Velbert (DE)

(72) Inventor: Mensur Velicanin, Velbert (DE)

(21) Appl. No.: 16/755,388

(22) PCT Filed: Oct. 11, 2018
(86) PCT No.: PCT/EP2018/077679

§ 371 Date: Apr. 10, 2020

(30) Foreign Application Priority Data
Nov. 24, 2017 (DE) 10 2017 127 870.2
Jan. 31, 2018 (DE) 10 2018 102 124.0

(51) Int. Cl. F16B 5/02; F16B 5/06

(52) U.S. Cl. CPC F16B 5/0233; F16B 5/065; F16B 37/068; F16B 5/0275; F16B 5/0225

(57) ABSTRACT

A motor vehicle fastening system for fastening a first motor vehicle component to a second motor vehicle component by a fastening device is provided. The fastening device includes a bolt element, a screw-on element and a tolerance element. The bolt element is connected to the second motor vehicle component in a rotationally fixed manner by screwing the bolt element into the second motor vehicle component up to a contact surface formed on the bolt element. The tolerance element is screwed onto the bolt element and also is supported against the first motor vehicle component such that the tolerance element can be moved relative to the first motor vehicle component along a first axis and a second axis. A screw-on element is arranged on a side surface of the first motor vehicle component facing away from the second motor vehicle component and is screwed onto the bolt element. A spacing element is arranged between the first motor vehicle component and the second motor vehicle component such that the spacing element arranges the first motor vehicle component at a predefined distance from the second motor vehicle component when the screw-on element loads the first motor vehicle component against the second motor vehicle component via the spacing element.

### CROSS REFERENCE TO RELATED APPLICATIONS

This application is a National Phase Application which claims priority under 35 U.S.C. § 371 to Patent Cooperation Treaty Application No. PCT/EP2018/077679, filed Oct. 11, 2018, which claims priority to German Application No. 102018102124.0, filed Jan. 31, 2018, which claims priority to German Application No. 102017127870.2, filed Nov. 24, 2017, the disclosures of which are incorporated herein by reference in their entireties.

### FIELD

The invention relates to a motor vehicle fastening system, having a first motor vehicle component, a second motor vehicle component with at least one threaded bore and at least one fastening device which detachably fastens the first motor vehicle component to the second motor vehicle component. The invention also relates to a method for fastening a first motor vehicle component to a second motor vehicle component using the motor vehicle fastening system according to the invention.

### BACKGROUND

This section provides background information related to the present disclosure and is not necessarily prior art.

Motor vehicle fastening systems for fastening a first motor vehicle component to a second motor vehicle component are known in principle. For example, a handle support is attached as a first motor vehicle component to a motor vehicle door as a second motor vehicle component, wherein door handles of the motor vehicle door are usually arranged on the handle support for the purpose of simple assembly. The handle support in turn is fastened on the inside of the motor vehicle door such that the door handle is accessible from a vehicle exterior through a through opening provided in the motor vehicle door. The assembly of the handle support on the inside of the door usually takes place with high demands on the positional accuracy of the handle support to be mounted, whereby tolerance compensation must always be observed so that the door handle or the handle support are fastened to the motor vehicle door free of play. For tolerance compensation, it is known that several threaded bores are formed in the second motor vehicle component, i.e. the motor vehicle door, and that the first motor vehicle component, i.e. the handle holder, has various screw or bolt receptacles, so that during assembly a suitable and aligned connection is sought among the threaded bore, and the screw or bolt receptacles through which the first motor vehicle component or the handle support can be fastened free of play to the second motor vehicle component or the motor vehicle door so that the door handle mounted on the handle support has a secure and stable fit. Nevertheless, there is always the problem that the first motor vehicle component or the handle bar is never arranged in parallel to the second motor vehicle component or the motor vehicle door so that there is always a risk that the connection of the two motor vehicle components nevertheless has a slight play, as a result of which both motor vehicle components can be moved relative to one another and, for example, the operator of a door handle (first motor vehicle component) can have the impression that it is loosened. Due to the high demands, in particular on the positional accuracy and freedom from play, the assembly of a door handle support is complex and correspondingly time-consuming.

### SUMMARY

This section provides a general summary of the disclosure, and is not a comprehensive disclosure of its full scope or all of its features.

It is the object of the invention to create a solution which provides an improved motor vehicle fastening system in a structurally simple manner, by which the disadvantages mentioned above are avoided and by which an inexpensive and universally applicable possibility is created to fasten a first motor vehicle component or a handle support time-efficiently on a second motor vehicle component or a vehicle door and also to meet the highest demands on positional accuracy.

In a motor vehicle fastening system of the type described above, the object is achieved according to the invention in that the bolt element has a third threaded portion which is formed between the first threaded portion and the second threaded portion, and has a contact surface arranged between the second threaded portion and the third threaded portion, wherein the at least one fastening device further has a screw-on element with an internal thread screwed onto the first threaded portion and a tolerance element which is supported against the first motor vehicle component in such a way that the tolerance element can be moved relative to the first motor vehicle component along a first axis and a second axis and has a through opening with an internal thread screwed onto the third threaded portion, wherein the bolt element is arranged passing through a through opening of the first motor vehicle component, and the screw-on element is arranged on a side surface of the first motor vehicle component facing away from the second motor vehicle component, wherein the second threaded portion of the bolt element that extends along a third axis is screwed onto the at least one threaded bore with its contact surface abutting the second motor vehicle component such that the bolt element is connected to the second motor vehicle component in a rotationally fixed manner, and wherein at least one spacing element is arranged between the first motor vehicle component and the second motor vehicle component, by means of which spacing element the first motor vehicle component is arranged at a predefined distance from the second motor vehicle component when the screw-on element loads the first motor vehicle component against the second motor vehicle component via the spacing element.

The object is also achieved according to the invention by a method of the type described above, wherein the third threaded portion of the bolt element is screwed into the tolerance element, wherein the second threaded portion of the bolt element is screwed into the at least one threaded bore of the second motor vehicle component until the contact surface abuts the second motor vehicle component and the bolt element is connected to the second motor vehicle component in a rotationally fixed manner, and wherein the screw-on element is screwed onto the first threaded portion until the screw-on element urges the first motor vehicle component in the direction of the second motor vehicle component and the spacing element abuts both the first motor vehicle component and the second motor vehicle component.

Advantageous and expedient embodiments and further developments of the invention result from the scope of the present disclosure.

The invention provides a motor vehicle fastening system which is characterized by a simple construction and nevertheless offers a highly effective possibility of compensating tolerances in the assembly of a first motor vehicle component on a second motor vehicle component, so that even if the two motor vehicle components are not aligned exactly parallel to one another, nevertheless a secure and firm fixation of the two motor vehicle components is achieved by the use of the invention. According to the invention, this is achieved, inter alia, by the tolerance element, which ensures that the bolt element is movable in a plane of the first and second axes, which can be an x-y plane in space, for example, so that the threaded bore in the second motor vehicle component can always be arranged in alignment with the internal thread of the tolerance element, whereby a connection of the two motor vehicle components free of play is achieved.

With regard to a simple manufacturing process with low costs for the manufacture of the individual parts of the motor vehicle fastening system, the invention provides in an embodiment that the first threaded portion, the second threaded portion and the third threaded portion are designed as a continuous single threaded portion on the bolt element.

In order to facilitate assembly, the invention further provides in an embodiment that the screw-on element is designed as a union nut within which an elastically deformable clamping element is arranged, via which the bolt element is connected to the screw-on element up to a predetermined assembly torque in a rotationally fixed manner, the union nut being rotatable relative to the bolt element when the predetermined assembly torque is exceeded. Accordingly, in an embodiment of the invention the screw-on element can be designed as a self-locking union nut.

In an embodiment of the invention it is particularly advantageous in terms of construction and simplifies assembly if the at least one spacing element is designed as a spacing insert which is molded onto the first motor vehicle component and extends in the direction of the second motor vehicle component and/or as a spacing insert which is molded onto the second motor vehicle component and extends in the direction of the first motor vehicle component. Of course, the at least one spacing element can also be designed as a separate part, which is not molded onto either the first or the second motor vehicle component. However, it significantly facilitates the assembly of the first motor vehicle component on the second motor vehicle component when the spacing element is fastened to or formed at one of the two motor vehicle components.

In a further advantageous embodiment, the invention provides that the contact surface is designed as an insert projecting laterally from the bolt element or as a locking ring detachably fixed to the bolt element. In the embodiment as a protruding insert, this does not necessarily have to be formed around the entire bolt element.

One possibility of a particularly compact design of the motor vehicle fastening system according to the invention is provided in an embodiment of the invention in that the first motor vehicle component has a receiving space in which the tolerance element is arranged and a through opening that extends through the first motor vehicle component and passes through the receiving space, the bolt element extending through the through opening.

To position the bolt element in one plane, the invention provides in a further embodiment that the through opening formed in the first motor vehicle component is dimensioned such that the bolt element within the through opening is movable relative to the first motor vehicle component in the direction of the first axis and the second axis. In doing so, the bolt element extends in the direction of the third axis and can be screwed in the direction of the third axis with the threaded bore of the second motor vehicle component, the third axis being perpendicular to the first axis and the second axis and the three axes being synonymous with the three spatial directions.

As a particular embodiment, the invention provides that the first motor vehicle component is designed as a handle support for bearing a door handle. As an additional embodiment, it is then conceivable that the second motor vehicle component is designed as a body portion of a motor vehicle door.

For the method according to the invention, the invention provides in an embodiment that a self-locking union nut is used as the screw-on element, which union nut is screwed onto the first threaded portion until a predetermined assembly torque is reached, no later than the second threaded portion is screwed into the threaded bore of the second motor vehicle component, so that the screw-on element is connected to the bolt element in a rotationally fixed manner, and the second threaded portion of the bolt element is screwed into the threaded bore of the second motor vehicle component by turning the screw-on element. Thus, in a first step of the assembly, the union nut can be used to screw the bolt element into the threaded bore of the second motor vehicle component.

In an advantageous embodiment, the method according to the invention provides that after the second threaded portion has been screwed in, a force for turning the screw-on element is applied which is greater than the predetermined assembly torque, whereby the screw-on element urges the first motor vehicle component in the direction of the second motor vehicle component.

It is to be understood that the abovementioned features and the following features still to be explained can be used not only in the combination indicated in each case, but also in other combinations or alone without departing from the scope of the present disclosure.

Further details, features and advantages of the subject matter of the invention result from the following description in connection with the drawing, in which an exemplary and preferred embodiment of the invention is shown.

### DRAWINGS

The drawings described herein are for illustrative purposes only of selected configurations and not all possible implementations, and are not intended to limit the scope of the present disclosure.

In the drawing:

FIG. 1 shows a perspective view of a motor vehicle fastening system for fastening a first motor vehicle component to a second motor vehicle component,

FIG. 2 shows a side view of the motor vehicle fastening system illustrated in FIG. 1,

FIG. 3 shows a sectional view of the illustration of FIG. 2, and

FIG. 4 shows a sectional view of the motor vehicle fastening system according to the invention.

Corresponding reference numerals indicate corresponding parts throughout the drawings

### DETAILED DESCRIPTION

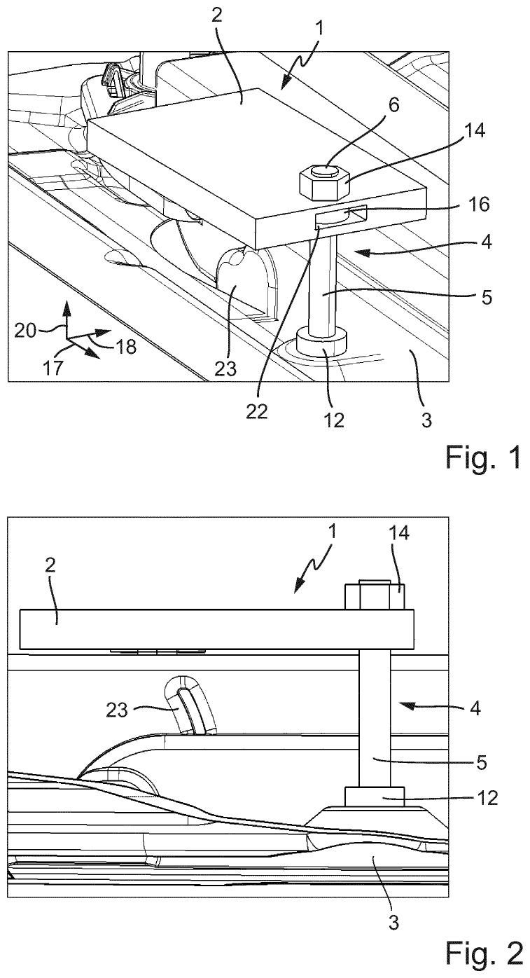

FIGS. 1 to 4 show a motor vehicle fastening system 1 according to the present invention, FIG. 1 showing a perspective view of motor vehicle fastening system 1. Motor vehicle fastening system 1 serves to detachably fasten a first motor vehicle component 2 to a second motor vehicle component 3. In the exemplary embodiment illustrated in FIGS. 1 to 4, the first motor vehicle component 2 is designed as a handle support, which is known to serve to pivotally bear a door handle of a door handle arrangement. Accordingly, second motor vehicle component 3 is designed as a body portion of a motor vehicle door or as motor vehicle door itself, to which first motor vehicle component 2 or the handle support with the door handle is fastened. First motor vehicle component 2 is detachably fastened to second motor vehicle component 3 by the use of a fastening device 4. In the exemplary embodiment shown, a single fastening device 4 is provided, and depending on the structural size of first motor vehicle component 2, a plurality of fastening devices 4 can also be provided in order to detachably fasten first motor vehicle component 2 to second motor vehicle component 3 free of play.

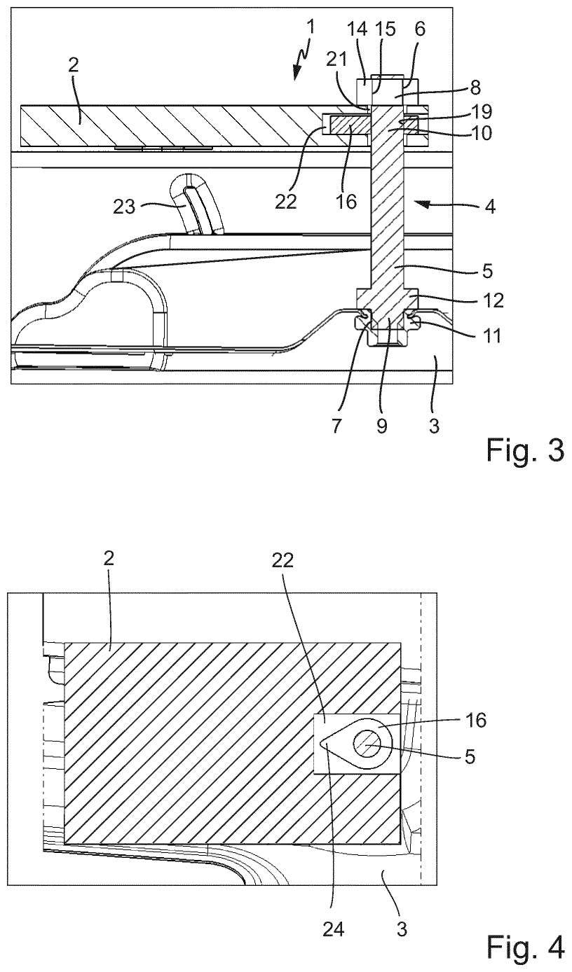

Fastening device 4 has a bolt element 5 with a first longitudinal end 6 and a second longitudinal end 7, as is shown, for example, in FIG. 3, which is a sectional side view of FIG. 2. At first longitudinal end 6 of bolt element 5 there is formed a first threaded portion 8 and at second longitudinal end 7 of bolt element 5 there is formed a second threaded portion 9, wherein a third threaded portion 10 is formed at bolt element 5 between the first threaded portion 8 and second threaded portion 9. For reasons of clarity, the three threaded portions 8, 9 and 10 of bolt element 5 are only shown in FIG. 3 and are provided with reference numerals. Second motor vehicle component 3 has a threaded bore 11 (see, for example, FIG. 3), into which second threaded portion 9 of bolt element 5 is screwed in the fastened state of first motor vehicle component 2 to second motor vehicle component 3. Bolt element 5 is screwed with its second threaded portion 9 into threaded bore 11 until a contact surface 12 which is arranged on bolt element 5 abuts the second motor vehicle component 3, so that bolt element 5 cannot be screwed any further into threaded bore 11. Rather, in this screwed-in position, bolt element 5 is connected to second motor vehicle component 3 in a rotationally fixed manner. Contact surface 12 of bolt element 5 is arranged between second threaded portion 9 and third threaded portion 10 and, in the exemplary embodiment illustrated, is designed as a circumferential insert, alternatively the insert does not have to be circumferential. In another alternative, contact surface 12 can be formed by a locking ring.

Fastening device 4 further comprises a screw-on element 14 with an internal thread 15, which screw-on element 14 is screwed onto first threaded portion 8 of bolt element 5. Thus, screw-on element 14 is arranged on a side surface of first motor vehicle component 2 facing away from second motor vehicle component 3, and, when screwed together, pushes first motor vehicle component 2 in the direction of second motor vehicle component 3. In the exemplary embodiment shown, screw-on element 14 is designed as a union nut, within which an elastically deformable clamping element is arranged, via which bolt element 5 is connected to screw-on element 14 up to a predetermined assembly torque in a rotationally fixed manner, screw-on element 14 or the union nut being rotatable relative to bolt element 5 when the predetermined assembly torque is exceeded in order to urge first motor vehicle component 2 in the direction of second motor vehicle component 3. In particular, screw-on element 14 can be designed as a self-locking union nut.

Furthermore, fastening device 4 has a tolerance element 16 which is supported at first motor vehicle component 2 and can be moved relative to first motor vehicle component 2 along a first axis 17 and a second axis 18 and has a through opening with an internal thread screwed onto third threaded portion 10. Bolt element 5 extending along a third axis 20 is arranged passing through a through opening 21 of first motor vehicle component 2, wherein screw-on element 14 is arranged on the side surface of first motor vehicle component 2 facing away from second motor vehicle component 3. Third axis 20 is perpendicular to first axis 17 and second axis 18 (see, for example, FIG. 1), the three axes 17, 18 and 20 being oriented on axes of an x-y-z coordinate system. First motor vehicle component 2 has a receiving space 22 (see for example FIGS. 1, 3 and 4) in which the tolerance element 16 is arranged, which is why tolerance element 16 cannot be seen in FIG. 2. A lateral opening is formed in first motor vehicle component 2, which lateral opening is connected to receiving space 22 and through which tolerance element 16 can be introduced into receiving space 22. Furthermore, through opening 21 mentioned above is formed in the first motor vehicle component 2 which through opening extends through first motor vehicle component 2 and passes through receiving space 22. In this case, bolt element 5 extends through through opening 21 and through receiving space 22, wherein the third threaded portion 10 of the bolt element 5 is screwed into internal thread 19 of tolerance element 16. Through opening 21 formed in first motor vehicle component 2 is dimensioned such that bolt element 5 can be moved within through opening 21 relative to first motor vehicle component 2 in the direction of the first axis 17 and the second axis 18.

It is essential for motor vehicle fastening system 1 according to the invention that second threaded portion 9 of bolt element 5 is screwed into the threaded bore 11 with its contact surface 12 abutting second motor vehicle component 3 in such a way that bolt element 5 is connected to second motor vehicle component 3 in a rotationally fixed manner. Only then does screw-on element 14 push first motor vehicle component 2 in the direction of second motor vehicle component 3 when turned during assembly. In order to load first motor vehicle component 2 against second motor vehicle component 3 without shaking and free of play, a spacing element 23 (see FIGS. 1 to 3) is arranged between first motor vehicle component 2 and second motor vehicle component 3. In the exemplary embodiment shown, spacing element 23 is designed as a spacing insert which is molded onto second motor vehicle component 3 and extends in the direction of first motor vehicle component 2. Alternatively, spacing element 23 could be designed as a spacing insert which is molded onto the first motor vehicle component 2 and extends in the direction of second motor vehicle component 3.

By means of spacing element 23, first motor vehicle component 2 is loaded against second motor vehicle component 3 at a predetermined distance by moving screw-on element 14 as far along first threaded portion 8 until spacing element 23 in the illustrated embodiment abuts first motor vehicle component 2. In other words, first motor vehicle component 2 is arranged at a predefined distance from second motor vehicle component 3 by spacing element 23 when screw-on element 14 loads first motor vehicle component 2 against second motor vehicle component 3 via spacing element 23. It should be noted that first threaded portion 8, second threaded portion 9 and third threaded portion 10 can be designed as a continuous single threaded portion on bolt element 5. FIG. 4 shows a sectional view, which shows receiving space 22 and tolerance element 16 arranged inside receiving space 22. Tolerance element 16 is disc-shaped and has a movement lug 24 which prevents tilting of tolerance element 16 within receiving space 22. Furthermore, tolerance element 16 is spaced from the wall of receiving space 22 so that bolt element 5 connected to tolerance element 16 can move within through opening 21 in the direction of first axis 17 and second axis 18, to compensate tolerances in the attachment of first motor vehicle component 2 to second motor vehicle component 3.

The method according to the invention uses the motor vehicle fastening system 1 described above to fasten first motor vehicle component 2 to second motor vehicle component 3. According to the method, in a first step, third threaded portion 10 of bolt element 5 is screwed into tolerance element 16. Subsequently, in a second step, second threaded portion 9 of bolt element 5 is screwed into the at least one threaded bore 11 of second motor vehicle component 3 until contact surface 12 abuts second motor vehicle component 3, whereby bolt element 5 is connected to second motor vehicle component 3 in a rotationally fixed manner. In a fourth step, screw-on element 14 is then screwed onto first threaded portion 8 until screw-on element 14 urges first motor vehicle component 2 in the direction of second motor vehicle component 3 and spacing element 23 abuts both first motor vehicle component 2 and second motor vehicle component 3.

In the method according to the invention a self-locking union nut can be used as screwing means 14, which union nut is screwed onto the first threaded portion 8 until a predetermined assembly torque is reached, no later than second threaded portion 9 is screwed into threaded bore 11 of second motor vehicle component 3, so that screw-on element 14 is connected to bolt element 5 in a rotationally fixed manner and the second threaded portion 9 of bolt element 5 is screwed into threaded bore 11 of second motor vehicle component 3 by turning screw-on element 14.

Furthermore, in the method according to the invention, after second threaded portion 9 has been screwed in, a force for turning screw-on element 14 can be applied which is greater than the predetermined assembly torque, whereby screw-on element 14 urges first motor vehicle component 2 in the direction of second motor vehicle component 3.

The described invention is of course not limited to the described and illustrated embodiment. In the embodiment illustrated in the drawing, numerous modifications can be made which are obvious to the person skilled in the art according to the intended application, without thereby departing from the scope of the invention. The invention includes everything that is contained in the description and/or shown in the drawing, including that which is different from the specific exemplary embodiment that is obvious to the person skilled in the art.

1. A motor vehicle fastening system comprising:
a first motor vehicle component;
a second motor vehicle component including at least one threaded bore; and
at least one fastening device detachably fastening the first motor vehicle component to the second motor vehicle component, the at least one fastening device including a bolt element with a first longitudinal end and a second longitudinal end, the first longitudinal end of the bolt element including a first threaded portion, and the second longitudinal end of the bolt element including a second threaded portion, characterized in that the bolt element including a third threaded portion and a contact surface, the third threaded portion formed between the first threaded portion and the second threaded portion, the contact surface arranged between the second threaded portion and the third threaded portion,
wherein the at least one fastening device includes a screw-on element and a tolerance element, the screw-on element including an internal thread screwed onto the first threaded portion, the tolerance element supported against the first motor vehicle component such that the tolerance element can be moved relative to the first motor vehicle component along a first axis and a second axis and has a through opening with an internal thread screwed onto the third threaded portion,
wherein the bolt element passes through a through opening of the first motor vehicle component, and the screw-on element is arranged on a side surface of the first motor vehicle component facing away from the second motor vehicle component,
wherein the second threaded portion of the bolt element that extends along a third axis is screwed onto the at least one threaded bore with the contact surface abutting the second motor vehicle component such that the bolt element is connected to the second motor vehicle component in a rotationally fixed manner, and
wherein at least one spacing element is arranged between the first motor vehicle component and the second motor vehicle component, the at least one spacing element arranging the first motor vehicle component at a predefined distance from the second motor vehicle component when the screw-on element loads the first motor vehicle component against the second motor vehicle component via the at least one spacing element.

2. The motor vehicle fastening system according to claim 1, wherein the first threaded portion, the second threaded portion, and the third threaded portion are designed as a continuous single threaded portion on the bolt element.

3. The motor vehicle fastening system according to claim 1, wherein the screw-on element is a union nut having an elastically deformable clamping element arranged therein, the union nut connecting the bolt element to the screw-on element up to a predetermined assembly torque in a rotationally fixed manner, the union nut being rotatable relative to the bolt element when the predetermined assembly torque is exceeded.

4. The motor vehicle fastening system according to claim 1, characterized in that wherein the at least one spacing element is designed (i) as a spacing insert which is molded onto the first motor vehicle component and extends in the direction of the second motor vehicle component and/or (ii) as a spacing insert which is molded onto the second motor vehicle component and extends in the direction of the first motor vehicle component.

5. The motor vehicle fastening system according to claim 1, wherein the contact surface is designed (i) as an insert projecting laterally from the bolt element or (ii) as a locking ring detachably fixed to the bolt element.

6. The motor vehicle fastening system according to claim 1, wherein the first motor vehicle component has a receiving space in which the tolerance element is arranged, and wherein the through opening extends through the first motor vehicle component and passes through the receiving space, the bolt element extending through the through opening.

7. The motor vehicle fastening system according to claim 1, wherein the through opening formed in the first motor vehicle component is dimensioned such that the bolt element within the through opening is movable relative to the first motor vehicle component in the direction of the first axis and the second axis.

8. The motor vehicle fastening system according to claim 1, characterized in that wherein the first motor vehicle component is designed as a handle support for bearing a door handle.

9. The motor vehicle fastening system according to claim 1, wherein the second motor vehicle component is designed as a body portion of a motor vehicle door.

10. A method for fastening a first motor vehicle component to a second motor vehicle component with the aid of the motor vehicle fastening system according to claim 1,
wherein the third threaded portion of the bolt element is screwed into the tolerance element,
wherein the second threaded portion of the bolt element is screwed into the at least one threaded bore of the second motor vehicle component until the contact surface abuts the second motor vehicle component and the bolt element is connected to the second motor vehicle component in a rotationally fixed manner, and
wherein the screw-on element is screwed onto the first threaded portion until the screw-on element urges the first motor vehicle component in the direction of the second motor vehicle component and the at least one spacing element abuts both the first motor vehicle component and the second motor vehicle component.

11. The method according to claim 10, wherein a self-locking union nut is used as the screw-on element, the union nut screwed onto the first threaded portion until a predetermined assembly torque is reached, no later than the second threaded portion is screwed into the threaded bore of the second motor vehicle component, so that the screw-on element is connected to the bolt element in a rotationally fixed manner and the second threaded portion of the bolt element is screwed into the threaded bore of the second motor vehicle component by turning the screw-on element.

12. The method according to claim 11, wherein after the second threaded portion has been screwed in, a force for turning the screw-on element is applied which is greater than the predetermined assembly torque, whereby the screw-on element 40 urges the first motor vehicle component in the direction of the second motor vehicle component.
